(19) United States
(12) Patent Application Publication
(10) Pub. No.: US 2003/0122876 A1
(43) Pub. Date: Jul. 3, 2003

(54) System and method for remote two-way control of communications between a computer and an auxiliary system

(75) Inventors: Amir Berlad, Givataim (IL); Yariv Cohen, Givataim (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: INTENSEWAVE Inc.

(21) Appl. No.: 10/266,590

(22) Filed: Oct. 9, 2002

(30) Foreign Application Priority Data
Dec. 31, 2001 (IL) 147415

(51) Int. Cl. G09G 5/00

(52) U.S. Cl. 345/773

(57) ABSTRACT

A remote control system comprising a two-way communication-capable remote controller having a remote display and a plurality of keys, a computer configured to download and store content such as music or video originating from an external source and to two-way communicate with the remote controller, and at least one auxiliary system such as a stereo or TV system configured to communicate with the computer and to exhibit the content. The remote controller controls the downloading and storing of the content on the computer and the playing or exhibition of that content on the auxiliary system through instructions input to the computer using the remote controller keys and displayed on its remote display.

### CROSS-REFERENCE TO RELATED APPLICATIONS

This application is entitled to the benefit of priority from Israel Patent Application No 147415, filed Dec. 31, 2001.

### FIELD AND BACKGROUND OF THE INVENTION

The present invention relates to systems and methods for downloading music (audio) and movies (video) from a computer network, specifically the Internet, and playing the downloaded material on regular audio (stereo) and video (TV, DVD) systems. More specifically, the present invention relates to systems and methods that enable to remotely control the play, display, order, choice and other operations regarding music and other content acquired on a computer, specifically a personal computer (PC), from a network (hereinafter “external source”), this content transferred to and played or “exhibited” on a regular stereo or TV system (hereinafter “auxiliary system”). In the following, “PC” is meant to represent all computer systems through which music, movies and other audio and video content can be downloaded from any source external to the PC, specifically the Internet.

Internet users commonly download music and movies from an external source such as the Internet (Web) or private networks in order to play them at home. Such downloading is expected to become the dominant distribution and purchasing channel in the future. Devices (including MP3-type) that allow storage and play of many songs on a headset or a stereo system are well known. However, regardless of the memory capacity of such devices, they eventually need more downloads from the network, and this requires connection to the network (e.g. the Web). Any regular PC can store a huge number of songs and offers a very comfortable way to download new ones.

The typical way of playing the PC-acquired digital music is through the PC speakers that are connected to the PC sound card, and are located on or near the computer. PC speakers are often of poor quality, and their sound is never as good as that heard through a regular audio receiver and regular stereo system speakers. There are known ways of connecting a PC to a stereo system to facilitate some of the operations mentioned above, but these connections are normally complicated and disadvantageous. For example X10 Ltd.'s (2 Sung Ping Street, Hunghom, Kowloon, Hong Kong) “MP3 anywhere” product consists of a transmitter that sends music from a PC to a stereo system, and a remote controller having one-way communication with the PC. The remote controller can control a few functions on the PC, e.g. changing a play list, changing a song, etc. However, since the communication is only one-way from the remote controller to the PC (i.e. the remote controller can send instructions to, but cannot receive input from, the PC), there is no information that is shown to a user on a display on the controller. Prior art remote controllers such as “MP3 anywhere” that are “talking” to PCs do not have a display, since one-way communication (from controller to PC) does not allow constant updates of such a display. Because of the lack of feedback to the user, the“MP3 anywhere” and similar remote controllers can only by used while keeping eye contact with the monitor (screen) of the computer, which means essentially that the user has to be in the same room as the computer. This is a major disadvantage, as it is uncomfortable to change songs without, for example, seeing the next song in line. Similarly, looking at the PC monitor from more then about 5 meters is also quite uncomfortable.

Another product that tries to answer the need of listening to music on a stereo system with the music originating from a PC is the “MP3 adapter” (MP3 Adapters, 2565 Broadway, Suite 406 New York, N.Y. 10025). The MP3 adapter is a plug that connects to the PC and splits the sound output into two outputs, one for the speakers and one for the stereo system. The plug has a long wire connected to the stereo system, which allows the transfer of the sound to the speakers. While providing a regular stereo sound to the music residing on the PC, this product does not allow control of the order of songs, Stop, Play, and other important functions. The only way to control these features is by using a mouse or a keyboard, which again forces the user to have eye contact with, and be physically close to the computer screen.

Normally, in order to control the played song or movie, there is a need for a user to operate the PC using its mouse or keyboard. The use of these devices for these tasks is uncomfortable, as they were not designed for these tasks. When the user is positioned far assay from the PC, with no visual contact with the screen, the control described above is even more difficult.

There is thus a widely recognized need for, and it would be highly advantageous to have, a system and method that provide remote two-way control of the communication between a PC and an auxiliary system. In particular, it would be highly advantageous to be able to transfer music residing on a PC to a stereo system and listen to it on that system, while the transfer and attending information gathering and manipulation are fully controlled by a remote controller that has two-way, wireless or wired communication with the PC.

### SUMMARY OF THE INVENTION

The present invention discloses in various embodiments a remote control system that provides a simple and comfortable way for controlling the playing on a stereo system of music residing on a PC (or the exhibition on a TV system of video pictures residing on the PC). The present invention also offers a user a very simple method for remotely controlling such functions as play and playing order of songs, playing time, volume, zoom and every other function of a CD or DVD player, while the user is situated for example in a living room, remote from the PC on which the music is stored. The system of the present invention provides the user with a remote controlled display of the songs stored on the PC, thus allowing him/her to control and use the huge database stored on the PC with the same simplicity as that of using a regular stereo system.

According to the present invention there is provided a two-way communication remote control system comprising: a two-way communication-capable remote controller having a remote display and a plurality of keys; a computer configured to download and store content originating from an external source and to two-way communicate with the remote controller; and at least one auxiliary system configured to communicate with the computer and to exhibit the content, wherein the downloading and storing of the content on the computer and the exhibition of the content on the at least one auxiliary system are performed upon instructions received from the remote controller through the keys, the instructions displayed on the remote display.

According to one feature in the two-way communication remote control system of the present invention, the communication between the remote controller and the computer is selected from the group consisting of communication through a wired connection and communication through a wireless connection, and the communication between the computer and each of the at least one auxiliary systems is selected from the group consisting of communication through a wired connection and communication through a wireless connection.

According to another feature in the two-way communication remote control system of the present invention, the at least one auxiliary system is a stereo system, and the two-way communication between the computer and the stereo system includes communication of music acquired by the computer from an external source such as the Internet.

According to the present invention there is provided a method to remotely control the two-way communication between a computer and at least one auxiliary system comprising the steps of: providing a two-way communication-capable remote controller having a remote display and a plurality of keys; and remotely controlling the two-way communication between the computer and the at least one auxiliary system employing instructions effected by at least one of the plurality of keys, and displaying the instructions on the remote display.

According to one feature in the method of the present invention, the at least one auxiliary system is a stereo system, and the two-way communication includes communication of music acquired by the computer from an external source such as the Internet.

According to the present invention there is provided a system for remotely controlling the transfer of music from a computer to a stereo system, comprising: a two-way communication-capable remote controller having a plurality of keys used to send instructions to, and extract information about the music from the computer, and a display used to display the instructions; a first communication link linking the computer and the stereo system; and a second communication link linking the remote controller and the computer, and used for the transfer of the music from the computer to the stereo system.

According to one feature in the system for remotely controlling the transfer of music from a computer to a stereo system, the first and second communication links are chosen from the group consisting of various permutations of wired links and wireless links.

According to the present invention there is provided a system for remotely controlling the transfer of video pictures from a computer to a TV system, comprising: a two-way communication-capable remote controller having a plurality of keys used to send instructions to, and extract information about the video pictures from the computer, and a display used to display the instructions; a first communication link linking the computer and the TV system; and a second communication link linking the remote controller and the computer, and used for the transfer of the video pictures from the computer to the TV system.

According to one feature in the system for remotely controlling the transfer of video pictures from a computer to a TV system, the first and second communication links are chosen from the group consisting of various permutations of wired and wireless links.

According to the present invention there is provided a remote controller for controlling the exchange of content between a PC and an auxiliary system, comprising: means for effecting direct full-duplex two-way communication and to transfer commands between the controller and the PC, a plurality of keys for effecting the commands, and a display for displaying the commands.

### BRIEF DESCRIPTION OF THE DRAWINGS

The invention is herein described, by way of example only, with reference to the accompanying drawings, wherein:

FIG. 1 shows a schematic description of a remote control system according to the present invention;

FIG. 2 shows a WildCat prototype version of the remote controller of the present invention:

FIG. 3 shows a schematic WildCat prototype implementation of the remote control system of the present invention;

FIG. 4 shows a block diagram of the main components of WildCat Remote Controller;

FIG. 5 shows a block diagram of the main components of the WildCat Base;

FIG. 6 shows an embodiment of the system with wired connections between the PC and the stereo system and between the PC and the remote controller;

FIG. 7 shows another embodiment of the system with wired connections between the PC and the stereo system and between the PC and the remote controller;

FIG. 8 shows an embodiment of the system with a wired connection between the PC and the stereo system and a wireless connection between the PC and the remote controller;

FIG. 9 shows an embodiment of the system with a wireless connection between the PC and the stereo system and a wired connection between the PC and the remote controller;

FIG. 10 shows another embodiment of the system with a wireless connection between the PC and the stereo system and a wired connection between the PC and the remote controller;

FIG. 11 shows an embodiment of the system with wireless connections between both the PC and the stereo system and the PC and the remote controller;

FIG. 12 shows another embodiment of the system with wireless connections between both the PC and the stereo system and the PC and the remote controller;

FIG. 13 shows an embodiment of the system with a plurality of stereo systems each controlled by a separate remote controller through a common PC;

### DESCRIPTION OF THE PREFERRED EMBODIMENTS

The present invention relates to systems and methods that enable to remotely control the play, display, order, choice and other operations regarding music and other content acquired from an external source (e.g. a network) through a computer, specifically a personal computer (PC), while the music is played on a regular stereo system. More specifically, the present invention is of a remote controller capable of two-way communication with a PC and, optionally, one-way communication with an auxiliary system such as a stereo system or a television set (“TV system”). The heart of the remote control system is a remote controller that has a display (hereinafter “remote display”), preferably a liquid crystal display (LCD), the controller being able to remotely control the PC, with all functions displayed on the remote display. This control refers mainly (but is not restricted) to the playing on a stereo system of songs that are stored on the PC, and to the changing of these songs by a predefined order. Similar remote control with full display functionality is provided for the playing on a television set of video pictures, movies and other visual content stored on the PC. The following description concentrates on the music application, with the understanding that the remote controller functionality enables equally well the two-way remote control of video communication between a PC and a TV set. The remote control system of the present invention offers the user a convenient way to play the music without seeing the PC screen, and without using a keyboard or mouse. The system allows full visualization on the remote display of, among other data, the status, length, artist, and different playing modes of a song. While the main object of the invention is to play music from the PC, many new features can be added to the remote controller by simply downloading a new update from the Internet. The set of keys on the remote display can assume different functionalities, upon instructions originating from the PC. For example, the same key can function as “Play” when used in audio mode, or “Zoom” when used in the DVD (video) mode. Since the remote display is capable of showing the different key functions, it is quite easy to control multiple applications from the same remote controller. The principles and operation of the system and method disclosed herein may be better understood with reference to the drawings and the accompanying description.

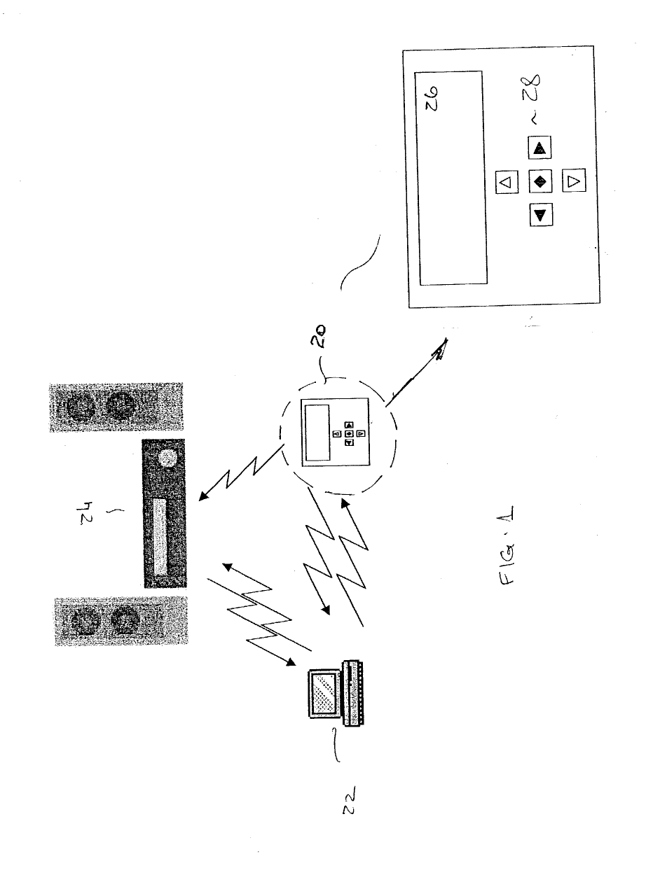

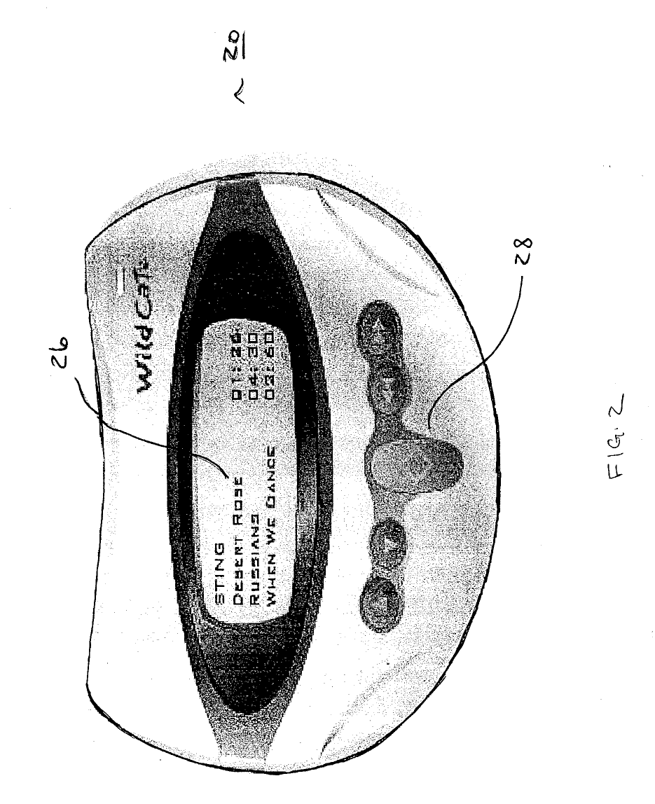

FIG. 1 shows a schematic description of the main elements of a preferred embodiment of the system. The key element of the system is a remote controller 20 capable of two-way full duplex communication (shown by directional zigzagged arrows), by either wired or wireless communication “links”. The system further comprises a PC 22 configured for two-way communication with remote controller 20, and an auxiliary system 24 in communication (shown by directional zigzagged arrows) either by physical means (e.g. wire) or wirelessly with PC 22. More that one auxiliary system can be connected to the PC, each of such systems remotely controllable through the PC by a remote controller. The two-way communication functionality of controller 20 is a key innovative element, and has no parallel in relevant remote control prior art systems. Remote controller 20, shown in more detail in a prototyped embodiment in FIG. 2, has a clear remote display 26 (e.g. a liquid crystal display (LCD), a light emitting diode (LED) display, a numeric display, etc) and a number of keys (also referred to as “switches” or “buttons”) 28 that can assume different functionalities, as detailed below. Such switches are made for example by Delixi Group Corp., Delixi Building, Liushi Town, Yueqing-325 604, China. Preferably, remote display 26 is a LCD display (e.g. model PC1602B manufactured by PowerTip, 18 Technology Drive, STE 161, Irvine, Calif. 92618, USA). The remote controller enables the user to choose the music that is stored on the PC, select and manipulate play lists (functions, such as Skip, Random Play, Repeat, Choose specific song), control the volume, etc. In a generic sense, this is referred to herein as “extracting information from the PC”. This information is shown on remote display 26. In addition, remote controller 20 can receive other information from software residing in the PC, e.g. E-mail, Instant Messaging, or stocks quotes, and display this information to the user on remote display 26. The system is further comprised of a Base unit 30 (hereinafter “Base”) that is always connected to PC 22 via one or more of the PC communication slots (parallel, serial, USB, FireWire or any other suitable communication slot). In a preferred wireless implementation, the remote controller communicates with the PC through the Base using a two-way wireless “link” on a frequency of 433 MHz.

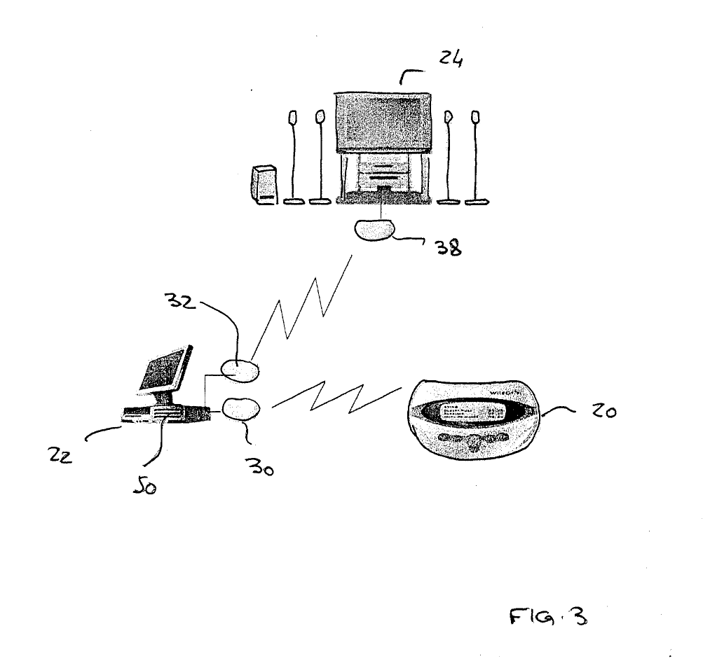

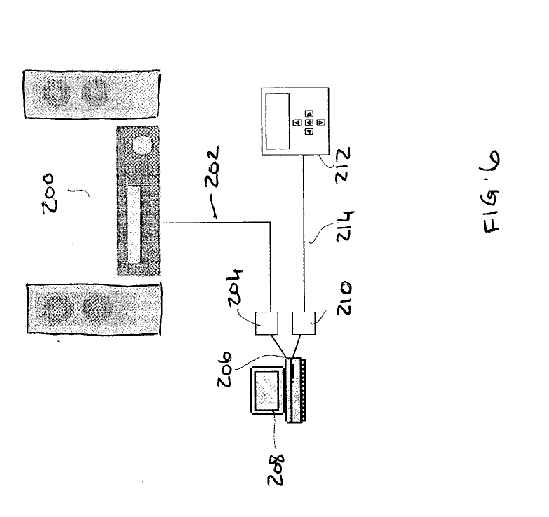

In a particular prototyped embodiment, shown in FIG. 3, the remote control system of the present invention is named “WildCat”, its various components named accordingly. The description below, while referring specifically to “WildCat” is not meant to be in any way restricted to the specific prototype or name, these being used for ease of explanation only. Thus, in FIG. 3, remote controller 20 is referred to as WildCat Remote Controller, and Base 30 is referred to as “WildCat Base”. Two-way communication between Base 30 and controller 20, and one or two-way communication between PC 22 and each auxiliary system 24 can occur through either fixed (physical) connections or by wireless connections. Such connections are well known in the art, and some of the connection possibilities between the PC and a stereo system and the PC and the remote controller are shown and described in FIGS. 6-13 below. For wireless communication with the stereo system, Base 30 further includes a transmitter/receiver Station unit 32. In FIG. 3, this is designated as “WildCat Station” 32. The WildCat Base and WildCat Station can reside in one combined physical unit. Wired connections between the PC and the auxiliary system remove the need for a WildCat Station. For wireless communication, the WildCat Station is normally a small transmitter unit (e.g. model FM2400TSIMB manufactured by Comtech Technology Co., Ltd. 2F No 42 Sec 3, Chung Yang Rd, Tu-Cheng, Taipei, Taiwan) connected to the sound card Audio Out socket of the PC. The transmitter transmits Hi-Fi stereo sounds in 2.4 GHz, 900 MHz or other RF frequencies to a receiver 38 (e.g. model FM2400TSIM2 manufactured by Comtech Technology Co.) connected to the Aux port of the stereo system. In FIG. 3, this receiver is shown as WildCat Receiver 38. The broadcast of the music can also be done to directly to the FM receiver of the stereo system in the 88-108 Megahertz bandwidth, or in AM. In these cases there is no need for a separate receiver attached to the stereo system.

Base 30 translates the signals that are sent from remote controller 20 to the relevant protocol in PC 22, and the signals sent from PC 22 to remote controller 20. For example, Base 30 receives from remote controller 20 a command for changing a song, and sends controller 20 the name of the next song that is stored in the PC memory or hard drive. The communication between Base 30 and PC 22 is further facilitated by a software module 50 installed on the PC. Software 50 translates the information sent to the PC from the Base. For example, software 50 finds all the play lists on the PC that were entered by external software or entered manually, and plays them using the PC sound card, or sends them digitally to another communication slot on the PC. While playing a song, software 50 sends information about the son, to Base 30, which in turn translates the information to appropriate (for example RF) commands, and sends them to remote controller 20. Such information may include for example the song name, the artist name, and the song length. The PC software thus “controls” the functions and responds to instructions from the remote controller, significantly simplifying the architecture and component cost of the controller. The remote controller of the present invention is thus clearly different, and much simpler that a two-way communication device such as a cellular telephone (cell-phone). Unlike a cell phone, in a preferred embodiment the remote controller of the present invention does not have a memory, and is basically a “dumb” thin client. The control function and attendant memory reside on the PC. In addition, unlike the transmission of a cell-phone that is indirect in the sense that it passes through relaying stations, the two-way communication here is direct: PC-to-controller and controller-to-PC.

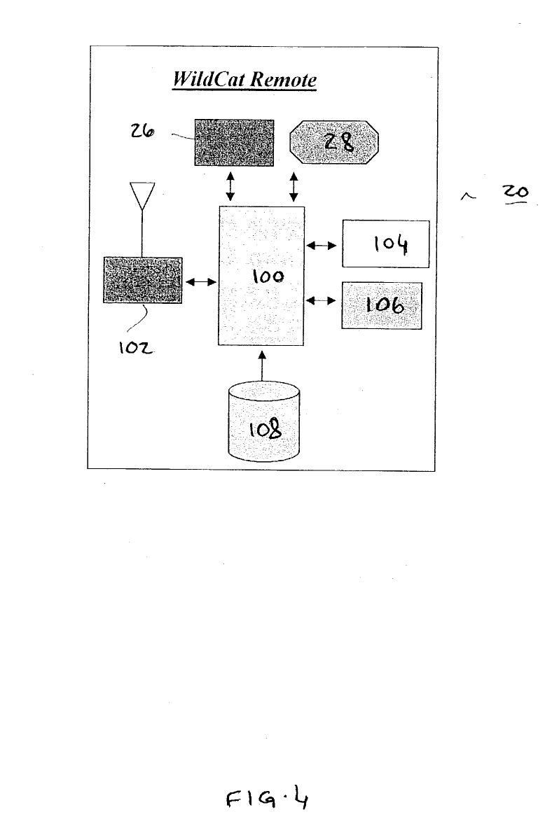

FIG. 4 shows a block diagram of the main components of WildCat Remote Controller 20. Controller 20 includes a remote microcontroller 100 (e.g. model AVR 9021200 made by Atmel Corporation, 2325 Orchard Parkway, San Jose, Calif., USA) for controlling the two-way communication function. Microcontroller 100 receives the commands sent from Base 30 using the communication protocol (that is, a decoder in the Base is translating the commands from the protocol to the PC input protocol), and displays them on remote display 26, which is connected to the remote controller keys. Each key is connected directly or indirectly to one or more of the interrupt inputs of microcontroller 100. The microcontroller scans the interrupt inputs to find out which key was pressed. When a key is pressed, the microcontroller sends a command to the Base stating the remote controller ID and the key that was pressed. Remote display 26 is as mentioned preferably a LCD display. In certain embodiments, i.e. when the controller-to-PC communication is wireless by RF, the controller includes a RF unit 102, (e.g. model nRF401 manufactured by Nordic VLSI ASA, Vestre Rosten 81, 7075 Tiller, Norway) connected to microcontroller 100. Controller 20 further includes a regulator 104 for timing the scanning of the keys and for modulating the RF transmission. Controller 20 further includes a programmable memory 106 for storing the remote controller ID, or in an alternative implementation, for serving as a temporary memory to store the displayed data when the remote controller is out of reach from the Base. Controller 20 further includes a power source 108, normally in the form of a battery, but which can also be a solar cell or a mini-fuel cell.

Direct communication between controller 20 and an auxiliary system is also possible, for example by adding to the controller an infrared (IR) LED connected to its microcontroller. This option is shown on FIG. 1 by an arrow 36. The remote microcontroller can store the commands that operate every stereo system brand, and after choosing the right set (either on the PC or on the remote display), send the right command via the IR LED to the stereo system by pressing a key (in the same well known manner that the controller of an original stereo system remote controls a TV). The remote controller can control any device via IR by either learning the specific commands of the device, or by downloading them from the network through the PC as described herein.

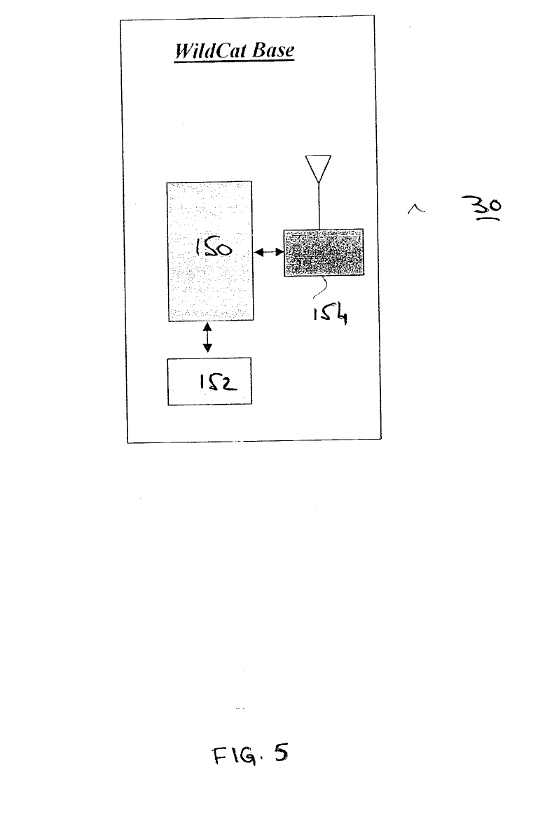

FIG. 5 shows a block diagram of the main components of WildCat Base 30. Base 30 includes a microcontroller 150 normally identical with remote microcontroller 100, which can process instructions and commands to and from the PC through a USB interface and power supply 152 (e.g. model PL2303, Prolific Technology Inc. 7F, No. 48, Sec. 3, Nan-Kang Rd., Taipei, Taiwan, R. O. C). For RF wireless communication, Base 30 further includes a RF unit 154, normally identical with RF unit 102, through which Base 30 communicates with the remote controller. Base 30 also has a decoder for decoding the PC protocol (not shown). Microcontroller 150 is also used for decoding the RF communication, as well as for receiving information from the decoder that decodes the PC protocol.

In typical use, software 50 that runs on the PC finds all the stored songs, music, or video files, and builds a database containing all the relevant characteristics (for example song name, artist, location on disk, song length, etc.). After the information is stored in the PC database, the software looks automatically, by pinging every port of the PC, for the location of the WildCat Base connection. When the software finds the right port, communication with the Base is enabled. The software then sends commands to the Base via the specified port, by RS232, USB, or any other commonly used protocols. Such commands may include: turn the remote controller light on, display A on a first position on the remote display, display C on a second position on the remote display, etc. The Base preferably transfers this information to the remote controller using RF communication at 433 MHz (or optionally at 900 MHz, 2.4 GHz or any other commonly used frequency) and the information is displayed on the remote display. Other wireless means for communication between the PC (through the attached Base) and the remote controller are possible, and these include infra-red, light and acoustical wave communications, all well-known in the art. Wired communication between the Base and the remote controller, either directly or through the house electric wires, phone lines, or any other known fixed electrical links is also possible, and covered by this invention.

In return, the remote controller sends the Base commands that are generated from pressing keys 28. The Base translates the commands and sends them to the Base-connection port of the PC. While running, software 50 scans the Base-connected port until it finds a command. When a command is found, the software executes the command and sends a feedback to the remote display of the remote controller. The software can send the controller information from every Web site if the PC is connected to the Internet, using preferably the same two-way RF communication method. In addition to controlling the communication between the remote controller and the PC, the software plays the current song or movie by decoding the format (MP3, WAV, etc.)

The connection (wired or wireless) between the PC and the auxiliary (e.g. stereo) system may be two-way. In order for the wired option to be two-way, there need to be two wires, one for the PC-to-stereo traffic, the other for the stereo-to-PC traffic. The remote controller is always able to control both ways. A two-way connection between the PC and the stereo system can thus also be used for sending music residing in the stereo system (e.g. on a CD player) to the PC for recording it in the PC memory. The music can be stored on the PC in any format, e.g. MP3.

Returning now to the figures, FIG. 6 shows a stereo system 200 connected via a physical, fixed (wired) electrical connection (e.g. a wire or cable) 202 to a Station unit 204 that is connected to one of the input/output ports 206 (USB, LPT, IR, COM or any other) of a PC 208. The software (not shown) running in the PC sends music (songs) to stereo system 200, and information about the songs to a Base unit 210 attached to the PC. Base 210 is connected (wired) via a similar physical connection 214 to a remote controller 212 (identical with controller 20 described in detail above) that displays the song information on its remote display, and enables various manipulations of the PC music content. In this embodiment, both PC-to-auxiliary (stereo) system, and PC-to-remote controller connections are wired. The communication between the PC and the controller is always two-way. In this embodiment the communication between the PC and the stereo system is one-way.

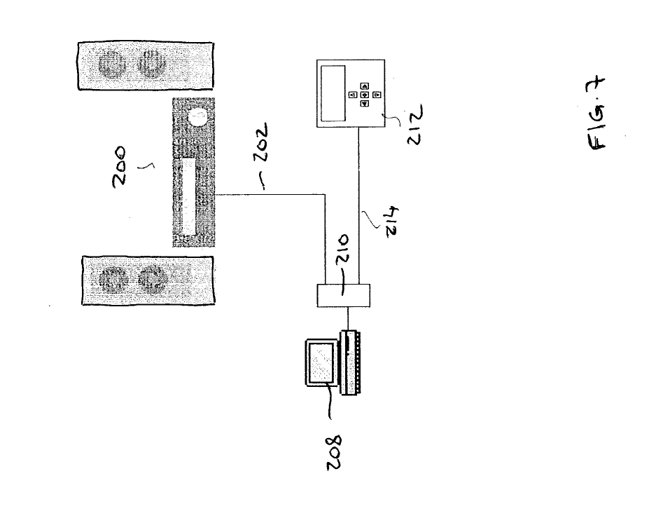

In FIG. 7, stereo system 200 is connected physically (wired) to Base 210 of PC 208, which in turn is wired to controller 212. In this embodiment there is no Station connected to the PC, and the communication between the PC and the stereo system can be one or two-way.

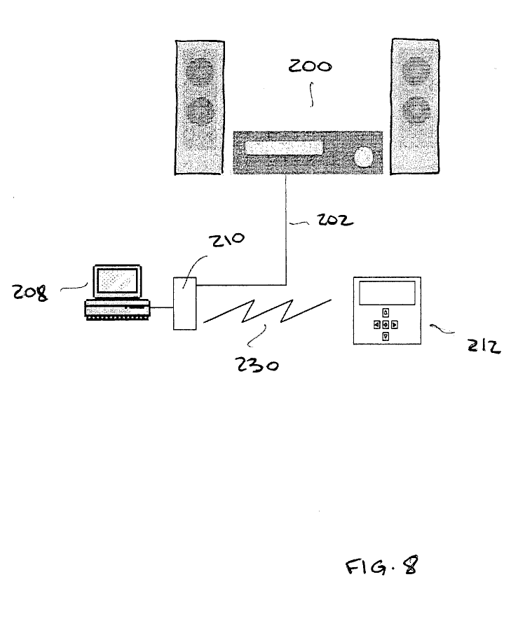

In FIG. 8, the connection between stereo system 200 and PC 208 is the same as in FIG. 7, i.e. fixed (wired), while a connection 230 between the PC and the remote controller is wireless. In this embodiment, the communication between the PC and the stereo system can be one or two-way.

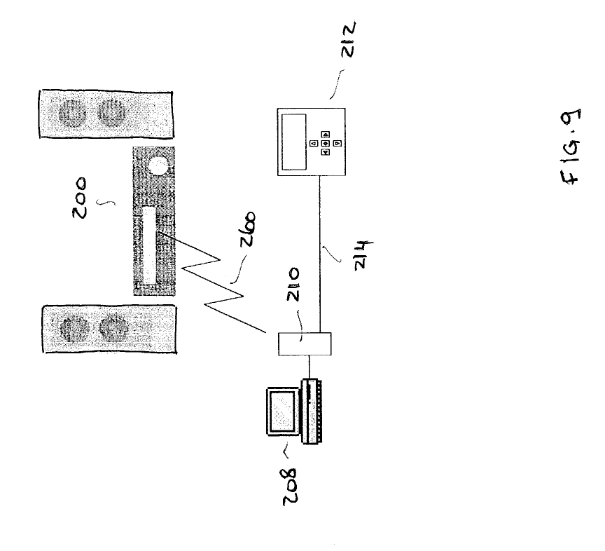

In FIG. 9, the connection between stereo system 200 and PC 208 is a wireless connection 260, while that between the PC and the remote controller is wired as in FIG. 6. In this embodiment, Base 210 includes a transmitter (not shown). The stereo system receives music wirelessly via its FM tuner from the Base transmitter, preferably as RF waves in 88-108 Megahertz band. In this embodiment, the communication between the PC and the stereo system is one-way.

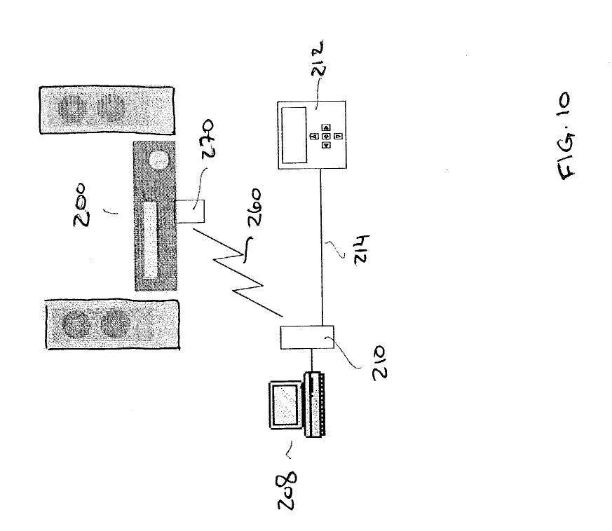

In FIG. 10, the stereo system is equipped with a transmitter/receiver 270 connected to the AUX port of the stereo system. The stereo system receives music from the PC wirelessly via transmitter/receiver 270 (using for example IR, RF, acoustical waves, etc). In this embodiment, the communication between the PC and the stereo system is two-way.

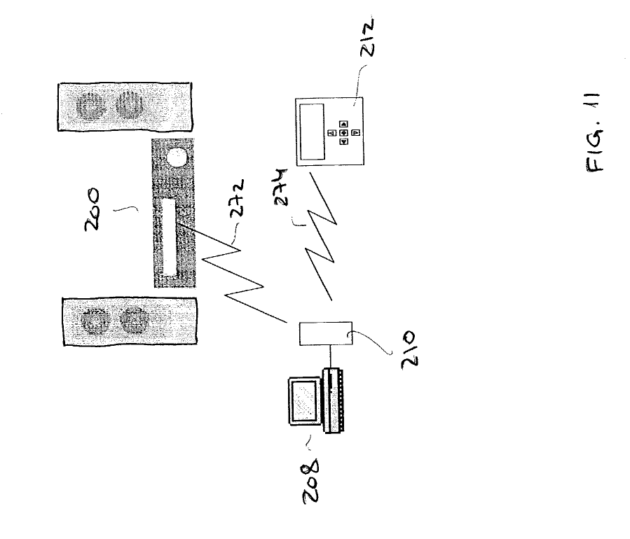

In FIG. 11, both the PC-to-stereo system and the PC-to-remote controller connections are wireless, with respective wireless connections 272 and 274. The PC-to-stereo transmission is as in FIG. 9. In this embodiment the communication between the PC and the stereo system is one-way.

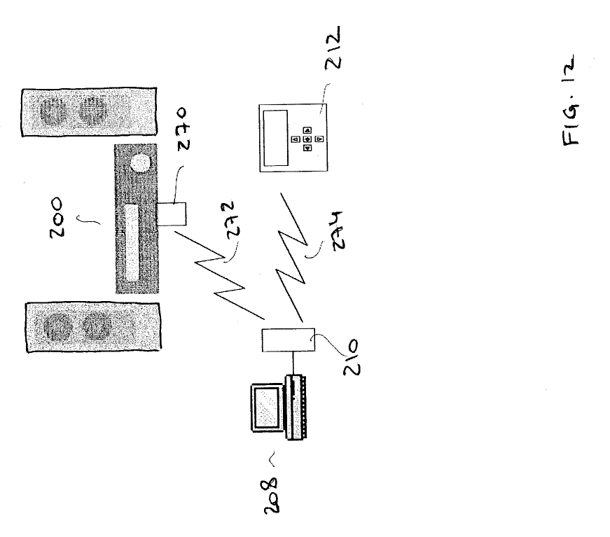

In FIG. 12, both connections are wireless as in FIG. 11, with the exception that the PC-to-stereo system connection is two-way, enabled by transmitter/receiver 270 on the stereo system.

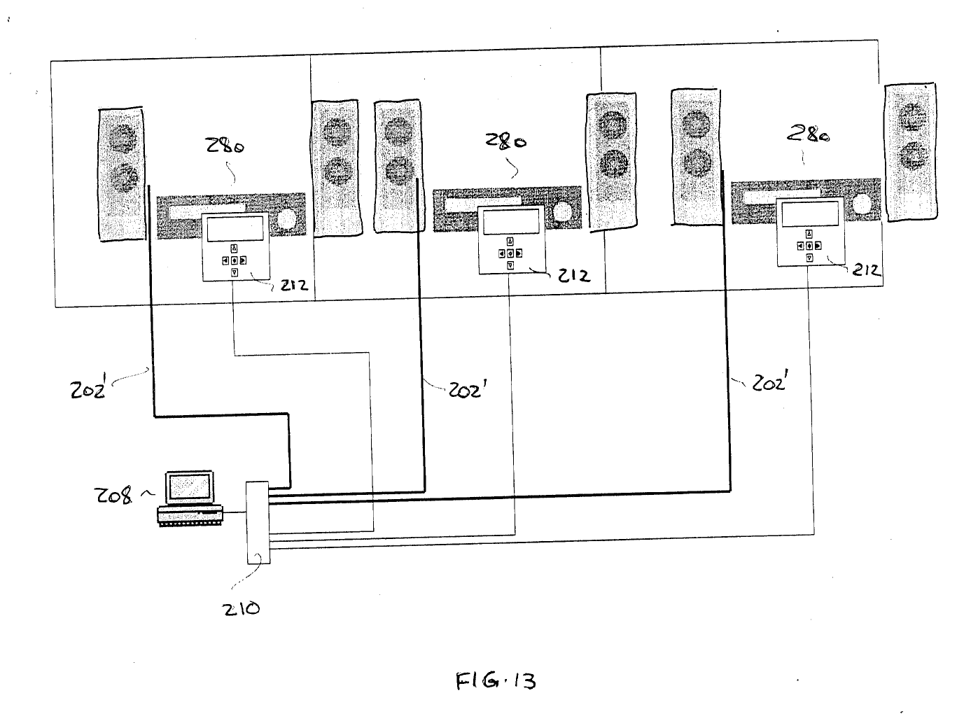

Finally, FIG. 13 shows a multi-auxiliary system embodiment. A number of stereo systems 280 reside separately, for example one in each room (rooms A, B, C) of a house, and are connected fixedly (wired) to a central PC 208 by wires 202′. In this embodiment, there are the same number of remote controllers 212 as stereo systems, one controller for each stereo system, each controller physically located in the same room as the stereo system it controls, and each controller fixedly connected to PC.

In summary, the main strength and advantage of the present invention is that it offers a complete solution for remotely controlling the listening to music that resides or originates from a PC or a network such as the Internet, without losing the comfort of a regular stereo system. Unlike other devices that might be able to control a PC, such as a cell phone or an IR remote controller, the communication here is two-way and controlled from the PC. Since the software on the PC sends the remote controller specific orders based on the desired outcome, much of the component cost in the remote controller is reduced. All that is needed in the remote controller is a RF unit and a display. There is no need for memory (unlike as in cell-phones or MP3 players). The remote control serves as a very thin client for the PC, and, with the changing key functionality, can control many of the functions of the PC. The software is Web upgradeable, which gives the user the option to add new abilities to the remote controller, or specifically customize it to his/her needs. The keys in the remote controller stay the same, but their functionality changes with each application.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A two-way communication remote control system comprising:
a) a two-way communication-capable remote controller having a remote display and a plurality of keys;
b) a computer configured to download and store content originating from an external source and to two-way communicate with said remote controller; and
c) at least one auxiliary system configured to communicate with said computer and to exhibit said content, wherein said downloading and storing of said content on said computer and said exhibition of said content on said at least one auxiliary system are performed upon instructions received from said remote controller through said keys, said instructions displayed on said remote display.

2. The system of claim 1, wherein said communication between said remote controller and said computer is selected from the group consisting of communication through a wired connection and communication through a wireless connection, and wherein said communication between said computer and each of said at least one auxiliary systems is selected from the group consisting of communication through a wired connection and communication through a wireless connection.

3. The system of claim 2, wherein said wireless communication between said computer and said remote controller is selected from the group consisting of infrared, radio frequency (RF) and acoustical wave communication.

4. The system of claim 3 wherein for said RF wireless communication between said remote controller and said computer said remote controller further includes:
i. a RF unit for effecting said two-way wireless communication,
ii. a micro-controller for controlling said two-way communication and said remote display of said instructions; and
iii. an independent power source for powering said RF unit, said micro-controller and said remote display.

5. The system of claim 1, wherein said configuration of said computer includes:
i. software installed on said computer, said software used to download and store said content originating from said external source and to facilitate said two-way communication with said remote controller and said at least one auxiliary system, and
ii. a Base unit connected to said computer and operative to effect said two-way communication with said remote controller.

6. The system of claim 2, wherein said computer includes a wireless transmitter, wherein said at least one auxiliary system includes a wireless receiver, and wherein said wireless communication between said computer and said least one auxiliary system is selected from the group consisting of infrared, radio frequency and acoustical wave communication.

7. The system of claim 5, wherein said Base unit further includes an interface for said connection to said computer, a transmitter/receiver unit for effecting said two-way communication with said remote controller, and a first microcontroller for controlling said effecting.

8. The system of claim 1, wherein said external source includes the Internet, wherein said at least one auxiliary system is a stereo system, and wherein said content includes music.

9. The system of claim 1, wherein said external source includes the Internet, wherein said at least one auxiliary system is a TV system, and wherein said content includes video pictures.

10. A method to remotely control the two-way communication between a computer and at least one auxiliary system comprising the steps of:
a) providing a two-way communication-capable remote controller having a remote display and a plurality of keys; and
b) remotely controlling the two-way communication between the computer and the at least one auxiliary system employing instructions effected by at least one of said plurality of keys, and displaying said instructions on said remote display.

11. The method of claim 10, wherein the at least one auxiliary system is a stereo system, and wherein said two-way communication includes communication of music acquired by the computer from an external source such as the Internet.

12. The method of claim 10, wherein the at least one auxiliary system is a television display, and wherein said two-way communication includes communication of video pictures acquired by the computer from an external source such as the Internet.

13. The method of claim 10, wherein said step of providing a two-way communication-capable remote controller includes providing a remote controller configured to two-way wirelessly communicate with the computer.

14. The method of claim 13, wherein said two-way wireless communication includes radio frequency wireless communication.

15. The method of claim 10, wherein said step of providing a two-way communication-capable remote controller includes providing a remote controller physically wired to the computer.

16. A system for remotely controlling the transfer of music from a computer to a stereo system, comprising:
a) a two-way communication-capable remote controller having a plurality of keys used to send instructions to, and extract information about the music from the computer, and a display used to display said instructions;
b) a first communication link linking the computer and the stereo system; and
c) a second communication link linking said remote controller and the computer, and used for the transfer of the music from the computer to the stereo system.

17. The system of claim 16, wherein said first and said second communication links are chosen from the group consisting of various permutations of wired links and wireless links.

18. A system for remotely controlling the transfer of video pictures from a computer to a TV system, comprising:
a) a two-way communication-capable remote controller having a plurality of keys used to send instructions to, and extract information about the video pictures from the computer, and a display used to display said instructions;
b) a first communication link linking the computer and the TV system; and
c) a second communication link linking said remote controller and the computer, and used for the transfer of the video pictures from the computer to the TV system.

19. The system of claim 18, wherein said first and said second communication links are chosen from the group consisting of various permutations of wired links and wireless links.

20. A remote controller for controlling the exchange of content between a PC and an auxiliary system, comprising:
a) means for effecting direct full-duplex two-way communication and to transfer commands between the controller and the PC;
b) a plurality of keys for effecting said commands; and
c) a display for displaying said commands.

21. The remote controller of claim 20, wherein said means for effecting direct full-duplex two-way communication include a RF unit for wireless RF communication.
